(19) United States
(12) Patent Application Publication
(10) Pub. No.: US 2013/0314699 A1
(43) Pub. Date: Nov. 28, 2013

(54) SOLAR RESOURCE MEASUREMENT SYSTEM

(71) Applicants: Roger L. Jungerman, Petaluma, CA (US); Randall King, Santa Rosa, CA (US)

(72) Inventors: Roger L. Jungerman, Petaluma, CA (US); Randall King, Santa Rosa, CA (US)

(73) Assignee: Solmetric Corp., Sebastopol, CA (US)

(21) Appl. No.: 13/845,017

(22) Filed: Mar. 17, 2013

Related U.S. Application Data
(60) Provisional application No. 61/652,090, filed on May 25, 2012.

(51) Int. Cl. G01J 1/02

(52) U.S. Cl. CPC G01J 1/0266
USPC 356/139.01

(57) ABSTRACT

A solar resource measurement system captures an orientation-referenced image within a field of view of a tilted surface that includes a skyline, detects the skyline within the orientation-referenced image to establish a set of zenith angles as a function of azimuth angles associated with the skyline, and determines a solar resource for the tilted surface from the orientation-referenced image and the set of zenith angles as the function of azimuth angles that are associated with the skyline.

### CROSS-REFERENCE TO RELATED APPLICATIONS

This application claims benefit of priority with U.S. Ser. No. 61/652,090, filed May 25, 2012, titled “SOLAR RESOURCE MEASUREMENT SYSTEM”; the contents of which are hereby incorporated by reference.

### BACKGROUND

Solar photovoltaic modules and other tilted surfaces within solar systems respond to both direct and diffuse solar radiation. Accordingly, to accurately assess solar energy that is available to a tilted surface, the direct and the diffuse solar radiation must be accounted for. Commercially available measurement instruments, such as the SUNEYE 210, from SOLMETRIC CORPORATION, Inc., assess available solar energy based on a shade analysis of the direct and diffuse solar radiation in the presence of obstructions. However, this shade analysis treats obstructions in the path of the direct solar radiation as completely blocking the direct solar radiation and does not account for the reflectance of the obstructions in the assessment of the available solar energy.

In The Long-Term Average Performance of Flat-Plate Solar-Energy Collectors, Solar Energy, Vol. 7, p. 53, 1965, Benjamin Y. H. Liu and Richard C. Jordan disclose that the solar radiation incident on a tilted surface typically includes both direct and diffuse solar radiation and that the diffuse solar radiation includes a component of diffuse incident radiation and a component of diffuse reflected radiation. Liu et al. designate an average reflectance to accommodate for the diffuse reflected radiation, rather than accounting for the actual reflectance of ground surfaces and other obstructions in the field of view of the tilted surface. Incident solar radiation scattered by these obstructions is not accounted for, even though this results in diffuse reflected radiation that would be available to the tilted surface.

In Performance Prediction of Grid-Connected Photovoltaic Systems Using Remote Sensing, IEA PVPS Task 2. Report IEA-PVPS T2-07:2008, March 2008, Didier Mayer, Lucien Wald, Yves Poissant, and Sophie Pelland use satellite images to remotely estimate total solar radiation referenced to a horizontal plane and to provide site-specific solar radiation data for many locations at various times. However, Mayer et al. disclose that the presence of localized regions of higher than average reflectance, such as a brightly colored building in the field of view of the tilted surface, may significantly impact the estimates of solar radiation that are derived from such satellite images. Mayer et al. show an example deviation of approximately twenty percent between measured solar radiation that is incident on a tilted surface and estimates of solar radiation based on databases, such as HelioClim-2, that are derived from satellite imagery.

In view of the above, there is a need for a system that accurately characterizes direct solar radiation and diffuse solar radiation, accounting for the reflectance of obstructions within the field of view of a tilted surface.

### SUMMARY

A solar resource measurement system is implemented according to a method and an apparatus according to alternative embodiments of the present invention. The SOLAR RESOURCE MEASUREMENT SYSTEM captures an orientation-referenced image within a field of view of a tilted surface that includes a skyline, detects the skyline within the orientation-referenced image to establish a set of zenith angles as a function of azimuth angles associated with the skyline, and determines a solar resource for the tilted surface from the orientation-referenced image and the set of zenith angles as the function of azimuth angles that are associated with the skyline.

### BRIEF DESCRIPTION OF THE DRAWINGS

The embodiments of the present invention can be better understood when the following detailed description is read with reference to the accompanying drawing figures. The components and various features of the figures are not necessarily drawn to scale. Where applicable and practical, like reference designators represent corresponding parts throughout the different views.

FIG. 1A shows a tilted surface at a measurement site suitable for a solar resource measurement system according to embodiments of the present invention.

FIG. 1B shows the tilted surface of FIG. 1A within a reference coordinate system.

FIGS. 2A-2B show the solar resource measurement system implemented as methods according to embodiments of the present invention.

FIGS. 3A-3B show the solar resource measurement system implemented as an apparatus according to embodiments of the present invention.

FIG. 4 shows an example of an orientation-referenced image, including a skyline, captured by the solar resource measurement system according to embodiments of the present invention.

### DETAILED DESCRIPTION

As used in the specification and appended claims, the terms “a”, “an” and “the” include both singular and plural referents, unless the context clearly dictates otherwise. Thus, for example, “a device” includes one device and plural devices.

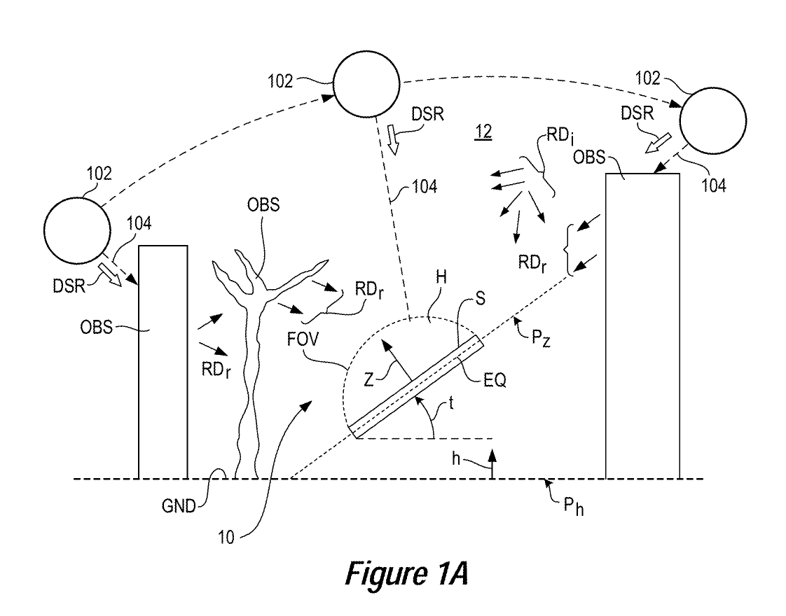

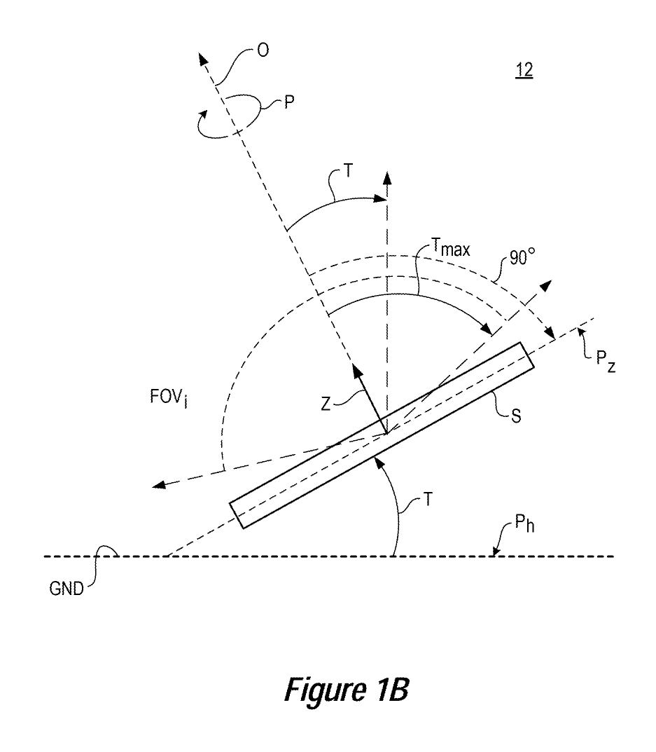

FIG. 1A shows a tilted surface S at a measurement site 10. The tilted surface S typically comprises one or more active or passive solar collectors, solar photovoltaic modules, thermal flat plate collectors, or other types of flat panels, devices, elements or subsystems that are typically included within a solar system. The element designator “S” is used interchangeably for each example type of tilted surface. The tilted surface S is shown having an associated tilt angle t relative to a horizontal plane that is parallel to the horizontal plane Ph of the ground GND. The horizontal plane Ph has a normal axis h that is orthogonal to the horizontal plane Ph. The tilted surface S has a field of view FOV that is hemispherical, with an equator EQ oriented within a plane Pz that contains the tilted surface S. The tilted surface S and the plane Pz have a normal axis z that is orthogonal to both the tilted surface S and the plane Pz.

The tilted surface S is shown in the presence of direct solar radiation DSR and diffuse solar radiation RD. The diffuse solar radiation RD is shown having components of diffuse incident radiation RDi and diffuse reflected radiation RDr. The relative amounts of direct solar radiation DSR and diffuse incident radiation RDi in the open sky 12 may depend on the weather conditions at the measurement site 10. On foggy days there may be substantially more diffuse incident radiation RDi than direct solar radiation DSR, whereas on clear days there may be substantially more direct solar radiation DSR than diffuse incident radiation RDi. Solar radiation that is available to the tilted surface S is typically expressed as a power density, in Watts/square meter of area, or in other suitable units.

Direct solar radiation DSR in the direct optical path, or sun path 104, between the sun 102 and the tilted surface S, is incident on the tilted surface S, except during the times of day or the times of year when the sun path 104 is blocked, and the tilted surface S is shaded by obstructions OBS. When these obstructions OBS are not within the sun path 104, the obstructions OBS do not block the direct solar radiation DSR from the field of view FOV of the tilted surface S. FIG. 1A shows different example positions of the sun 102, and the corresponding sun paths 104 and direct solar radiation DSR at those example positions.

In addition to influencing the amount of direct solar radiation DSR incident on the tilted surface S, the obstructions OBS, such as nearby buildings or trees, and portions of the ground GND, may also influence the amount of diffuse solar radiation RD that is incident on the tilted surface S. The obstructions OBS, the ground GND, and other objects within the field of view FOV of the tilted surface S are hereinafter collectively referred to as “obstructions OBS”.

When the diffuse incident radiation RDi and diffuse reflected radiation RDr are referenced to the plane Pz of the tilted surface S (referred to as being “referenced to the plane of the tilted surface S” or “in the plane of the tilted surface S”), the additional subscript “z” is included, which results in the designations of diffuse incident radiation “RDiz” and diffuse reflected radiation “RDrz”, respectively. This subscript “z” hereinafter indicates this reference to the plane Pz of the tilted surface S. When the diffuse incident radiation RDi and diffuse reflected radiation RDr are referenced to the horizontal plane Ph, representing a tilt angle t equal to zero, (referred to as being “referenced to the horizontal plane” or “in the horizontal plane”), the additional subscript “h” is included, which results in designations of diffuse incident radiation “RDih” and diffuse reflected radiation “RDrh”, respectively. This subscript “h” hereinafter indicates this reference to the horizontal plane Ph or other suitable horizontal planes that are parallel to the horizontal plane Ph.

The diffuse incident radiation RDi may be represented as uniform or non-uniform in the regions of open sky 12, which is the portion of the sky that is not blocked by the obstructions OBS. The obstructions OBS present in the field of view FOV of the tilted surface S scatter the direct solar radiation DSR and the diffuse incident radiation RDi, according to the reflectance, or “albedo” AB of the obstruction OBS. This scattering produces the diffuse reflected radiation RDr. The sum of the direct solar radiation DSRZ in the plane of the tilted surface S, the diffuse incident radiation RDiz in the plane of the tilted surface S, and the diffuse reflected radiation RDrz in the plane of the tilted surface S represent the total solar radiation TSRz in the plane of the tilted surface S. In the example where the tilted surface S comprises one or more solar photovoltaic modules S within a solar system, each of the components of the total solar radiation TSRZ contribute to the electrical output of the solar system.

In an example where the tilted surface S has a horizontal orientation, corresponding to a tilt angle t=0, and when there are no nearby obstructions OBS above the horizon to scatter or reflect the diffuse incident radiation RDiz, there is no diffuse reflected radiation RDrz incident on the tilted surface S. However, in solar systems the tilted surface S is typically oriented to have a tilt angle t that is greater than zero degrees but less than ninety degrees. In this more typical orientation, the diffuse reflected radiation RDrz that is available to the tilted surface S follows the cosine relationship RDrz=0.5*AB*(1−cos(t)), where “AB” represents the albedo of the obstructions OBS that are in the field of view FOV of the tilted surface S. For tilted surfaces S that are oriented at larger tilt angles t, the albedo AB of the obstructions OBS typically has correspondingly more of an influence on the diffuse reflected radiation RDrz that is incident on the tilted surface S.

The albedo AB typically depends on the optical attributes of the obstructions OBS that scatter or reflect solar radiation. At some measurement sites 10, the albedo AB may be seasonally dependent. For example, the presence or absence of winter snow cover may cause the albedo AB to vary over a wide range of values. Table 1 shows examples of albedo AB, expressed as a percentage reflectance, for various obstructions OBS that may be present in the field of view FOV of the tilted surface S.

TABLE 1

| Material | Albedo |
|---|---|
| Fresh Snow | 80%-95% |
| Light Roof | 35%-50% |
| Brick, stone | 20%-40% |
| Grass | 25%-30% |
| Forests | 10%-20% |
| Concrete | 17%-27% |
| Asphalt | 5%-10% |

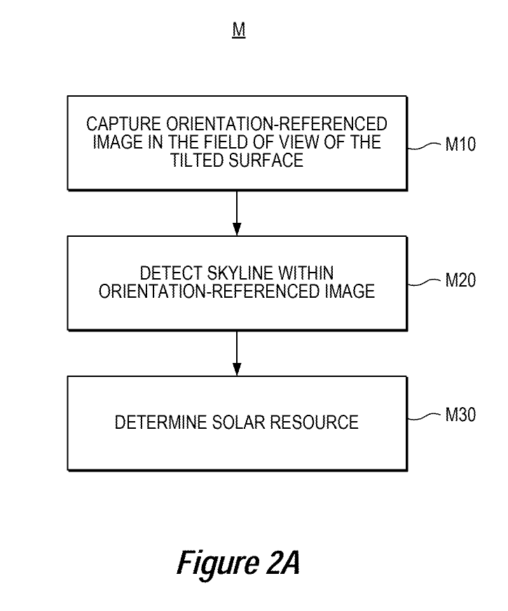

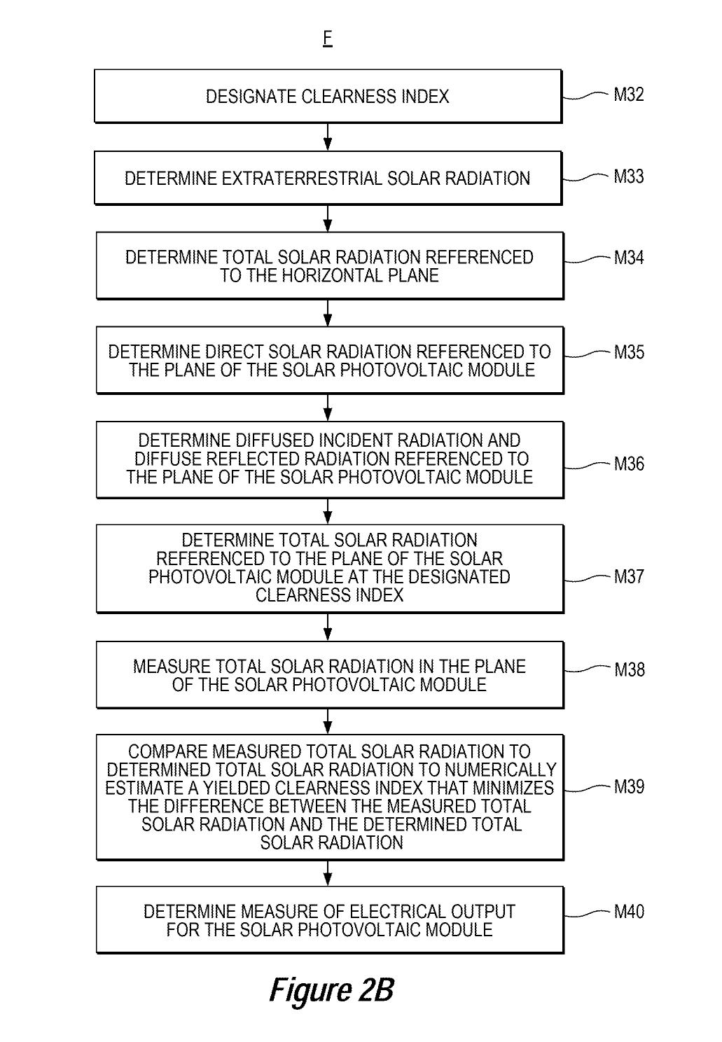

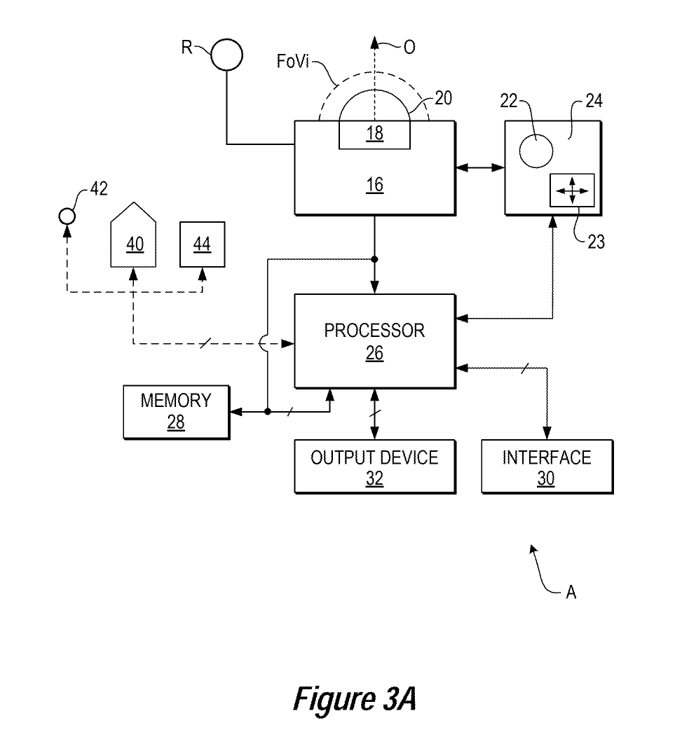

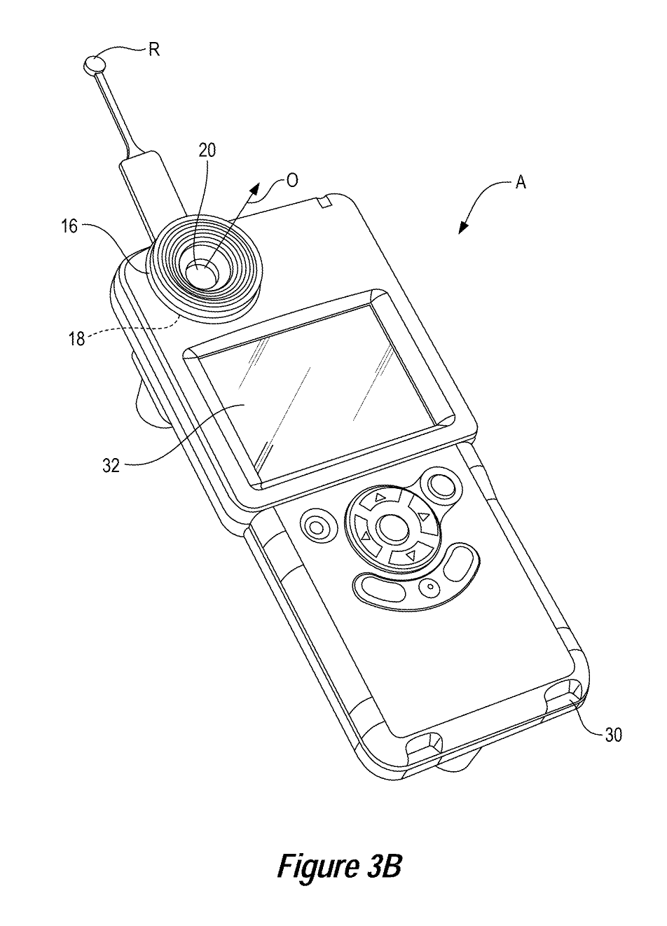

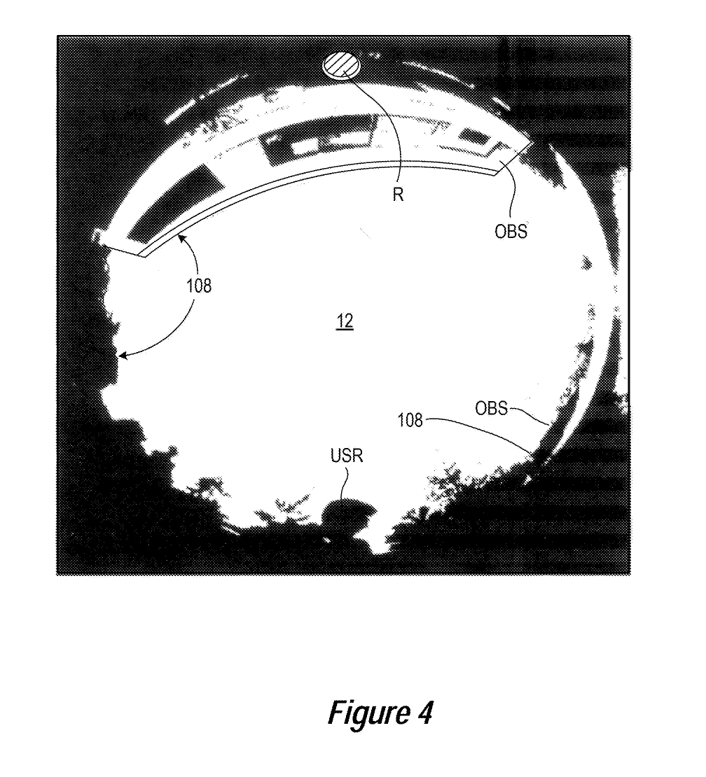

A solar resource measurement system is implemented as a method M (shown in FIGS. 2A-2B), or as an apparatus A (shown in FIGS. 3A-3B) according to alternative embodiments of the present invention. Step M10 of the method M includes capturing, at the measurement site 10, an orientation-referenced image 14 that includes a skyline 108, as shown in FIG. 4. A solar access measurement device (hereinafter “SAMD”), disclosed by Willard S. MacDonald in U.S. Pat. No. 7,873,490 (hereinafter “MacDonald”), captures images with known azimuth orientation provided by a compass, and with known 2-axis tilt provided by a tilt sensor. MacDonald's images are typically oriented in the horizontal plane Ph and typically cover a range of azimuth angles of approximately 180 degrees, which is sufficiently wide to encompass sun paths 104 in the context of determining solar access to direct solar radiation DSR and diffuse incident radiation RDi, as shaded by obstructions OBS in the sun paths 104. According to embodiments of the present invention, by using an image acquisition system 16 with an image sensor 18 and a fisheye lens 20, and an orientation-detection unit 24 including a compass 22 and tilt sensor 23 (shown in FIG. 3A), the orientation-referenced image 14 encompasses a range of azimuth angles p of 360 degrees, and may be referenced to the plane Pz of the tilted surface S at the tilt angle t.

The tilted surface S is shown in FIG. 1B within a reference coordinate system that includes the normal axis z, which is orthogonal to the plane Pz of the tilted surface S. A zenith angle T is shown relative to the normal axis z, so that a zenith angle T equal to 0 degrees indicates a zenith direction that is parallel to the normal axis z, and a zenith angle T equal to 90 degrees indicates a zenith direction that is within the plane Pz of the tilted surface S. The azimuth angle φ varies from 0 to 360 degrees about the normal axis z, so that the range of zenith angles T such that 0<T<90 and the range of azimuth angles p such that 0<p<360 define a field of view FOVi for the image acquisition system 16 that is substantially hemispherical. The fisheye lens 20 in the image acquisition system 16 (shown in FIG. 3A) enables the orientation-referenced image 14 to include a substantial portion of the field of view FOV of the tilted surface S within a single image. However, in practice, the field of view FOVi provided by the image acquisition system 16 may be slightly reduced relative to the FOV of the tilted surface S due to imperfections in the fisheye lens 20, which results in the field of view FOVi having a maximum zenith angle T_max that is slightly less than 90 degrees. To accommodate for the reduced field of view FOVi, image characteristics in the orientation-referenced image 14 that are within the range of zenith angles T such that T_max<T<90 are typically extrapolated from nearby image characteristics at zenith angles T that are close to, but less than, the maximum zenith angle T_max. This extrapolation is typically applied over the entire range of azimuth angles p of 360 degrees to provide for a resulting field of view FOVi for the image acquisition system 16 that is substantially hemispherical.

The orientation-referenced image 14 is typically captured with the image acquisition system 16 oriented in the plane of the tilted surface S, so that an optical axis O of the image acquisition system 16 (shown in FIG. 3A-3B) is aligned parallel to the normal axis z. In examples where the orientation-referenced image 14 is captured at other orientations, misalignments between the optical axis O of the image acquisition system 16 and the normal axis z may be digitally corrected so that pixels within the orientation-referenced image 14 are mapped to positions within the reference coordinate system shown in FIG. 1B. The zenith angle T and azimuth angle p for pixels in the orientation-referenced image 14 may be adjusted for such offsets or misalignments by applying a two-axis matrix rotation to correct for the offsets in the zenith angle T and the offsets in azimuth angles p as determined by the compass 22 and tilt sensor 23 within the orientation determination unit 24 (shown in FIG. 3A). This correction reconciles the field of view FOVi of the image acquisition system 16 with the field of view FOV of the tilted surface S, so that there is a correspondence between the field of view FOV and the field of view FOVi. Aligning the optical axis O to the normal axis z enables the resulting orientation-referenced image 14 to provide a suitable basis to accurately measure the diffuse incident radiation RDiz and the diffuse reflected radiation RDrz and account for the albedo AB of the various obstructions OBS in the field of view FOVi at the measurement site 10.

While a tilted orientation for the image acquisition system 16 at, or near, the tilt angle t typically provides a field of view FOVi for the image acquisition system 16 that approximates the field of view FOV of the tilted surface S, horizontal orientations or other orientations of the image acquisition system 16, may alternatively be used. However, accuracies with which the solar resource may be determined at the measurement site 10 may decrease when the field of view FOVi of the image acquisition system 16, due to the orientation of the image acquisition system 16, is insufficient to encompass all of the significant obstructions OBS that are within the field of view FOV of the tilted surface S.

An image sensor 18 within the image acquisition system 16 typically includes rows and columns of detector elements or pixels (not shown), which are position-calibrated using objects at known positions. This establishes a mapping between the positions of pixels in the rows and columns in the image sensor 18 at each degree of zenith angle T and each degree of azimuth angle p in the field of view FOVi. In zenith directions near a zenith angle T=0, a single pixel may correspond to several nearby zenith angles T due to limited resolution in the image sensor 18. In other zenith directions, several nearby pixels may correspond to a single zenith angle T and azimuth angle p, and the intensity values at these nearby pixels are typically averaged.

Scale factors for the intensity gain of pixels within the image sensor 18 may be established as a function of zenith angle T and azimuth angle p. In one example, this is achieved by positioning test objects having known intensity at various known azimuth angles p and zenith angles T while recording the resulting intensity values of pixels at the corresponding locations. The known intensity of the test objects and the resulting intensity values of the pixels result in an array of one or more scale factors for the intensity values of various pixels in the image sensor 18 at the various corresponding zenith angles T and azimuth angles p. When applied to an orientation-referenced image 14, the array of scale factors provides a calibrated, or normalized, intensity gain for pixels in the orientation-referenced image 14, resulting in an absolute intensity calibration.

In addition to normalizing the intensity gain of the orientation-referenced image 14, the image sensor 18 is typically calibrated to achieve uniform intensity sensitivity over the full field of view FOVi. In one example, the intensity sensitivity is calibrated over the field of view FOVi of the image acquisition system 16 by using an illuminated dome of constant reflectance to uniformly illuminate the field of view FOVi and establish an unnormalized calibration array. The unnormalized calibration array may then be applied to pixels within the image sensor 18 to achieve pixel values of correspondingly uniform intensity. In an alternative example, the intensity sensitivity is calibrated over the field of view FOVi by moving an illumination source having constant intensity through a range of zenith angles T and azimuth angles p, while recording the resulting relative intensity value of pixels at the corresponding zenith angle T and azimuth angle p to establish the unnormalized calibration array.

Multiple images may be taken at different exposures to accommodate a wide range of illumination intensities in the orientation-referenced image 14, for example when the sun 102 is present within the field of view FOVi and the solar radiation from the sun 102 saturates the image sensor 18. In this example, a resulting orientation-referenced image 14 having high dynamic range may be constructed by selecting pixels from each of the multiple images that have intensity values that are inside a range of intensity values that correspond to complete darkness and complete light saturation. By scaling the selected pixels according to the exposure of each corresponding image from which the pixels were selected, a composite image for the orientation-referenced image 14 may be constructed. This composite image typically results in an orientation-referenced image 14 that has fewer pixels that represent complete dark or complete light saturation, and enables an accurate characterization of the albedo AB of the obstructions OBS within the FOVi of the resulting orientation-referenced image 14.

In one example, capturing the orientation-referenced image 14 in step M10 involves a user of the SRMD positioning the image acquisition system 16 on the tilted surface S and then moving out of the field of view FOVi, so that the user is not present in the field of view FOVi during capture of the orientation-referenced image 14. In another example, the image acquisition system 16 is mounted on a tripod (not shown) and oriented in the plane Pz of the tilted surface S with the optical axis O aligned with the normal axis z to capture of the orientation-referenced image 14. A delayed action trigger may be programmed into the image acquisition system 16 to provide sufficient time for the user to move out of the field of view FOVi. In another example, if the user USR of the solar resource measurement system is captured within the orientation-referenced image 14 as shown in FIG. 4, the representation of the user USR and any other unwanted features in the orientation-referenced image 14 may be edited out of the orientation-referenced image 14 prior to further processing within the method M or apparatus A implementations of the solar resource measurement system. This editing typically involves interpolating intensity values of pixels that are edited out of the orientation-referenced image 14 with pixels that are nearby to the image of the user USR within the orientation-referenced image 14.

In alternative examples, the orientation-referenced image 14 is captured via an image acquisition system 16 that includes a camera or other device, element or system with a conventional camera lens that is sufficient to provide a photograph or digital image of a reflective dome. The reflective dome is typically positioned at the measurement site 10 to reflect an image to the camera in the image acquisition system 16 so that the field of view FOVi that includes the skyline 108 is represented in the reflected image over the full range of azimuth angles p. The orientation-referenced image 14 may alternatively be captured using a series of photographs that are electronically stitched together to represent the field of view FOVi that contains the skyline 108 over the full range of azimuth angles p.

The example of the orientation-referenced image 14 in FIG. 4 includes an optional reference reflector R. Typically, the reference reflector R is sufficiently small to not obscure a significant portion within the field of view FOVi. The optionally-included reference reflector R may be positioned relative to the image acquisition system 16 as shown in the apparatus A of FIGS. 3A-3B so that the reference reflector R is below the skyline 108 in the orientation-referenced image 14. If the reference reflector R intersects the skyline 108 then obstructions OBS that are behind the reference reflector R in the skyline 108 may be filled in by interpolation across the region of the orientation-referenced image 14 that is occupied by the reference reflector R. The sufficiently small portions of the reference reflector R that are below the skyline 108 in the orientation-referenced image 14 may optionally be excluded from calculations of average reflectance or average albedo AB_ave according to some embodiments of the solar resource measurement system.

Step M20 of the method M shown in FIG. 2A includes detecting the skyline 108 within the orientation-referenced image 14. The skyline 108 is defined by the boundary between the open sky 12 and the obstructions OBS in the field of view FOVi of the tilted surface S. In one example, the skyline 108 is automatically detected within the captured orientation-referenced image 14 based on an automated analysis of the values of pixels in a captured image to determine the boundary between the open sky 12 and obstructions OBS. Alternatively, a user may electronically draw or otherwise designate the skyline 108 within the orientation-referenced image 14. MacDonald and others disclose skyline detection techniques for shade analysis within a range of azimuth angles that are approximately 180 degrees. These skyline detection techniques, when extended to encompass a full 360 degrees range of azimuth angles p are suitable to detect the skyline 108 within the orientation-referenced image 14 according to embodiments of the present invention.

Detecting the skyline 108 in step M20 provides a set of pixels at zenith angles T_skyline(p) that are a function of the azimuth angle p. The set of pixels at these zenith angles T_skyline(p) over the full 360 degrees range of azimuth angles p, define the skyline 108 within the orientation-referenced image 14. At each azimuth angle p, the zenith angles T such that 0<T<T_skyline(p) indicate regions of the open sky 12 (shown in FIG. 4) within the orientation-referenced image 14. At each azimuth angle p, the zenith angles T such that 90>T≧T_skyline(p) indicate the obstructions OBS that are below the skyline 108 within the orientation-referenced image 14. The obstructions OBS below the skyline 108 contribute to the albedo AB and influence the amount of solar radiation that is available to the tilted surface S.

Step M30 of the method M shown in FIG. 2A includes determining a solar resource, such as the albedo AB, which accounts for the reflectance or scattering of solar radiation by the obstructions OBS that are below the skyline 108 within the orientation-referenced image 14. Typically, after capturing the orientation-referenced image 14, the intensity values of pixels within the orientation-referenced image 14 are stored in a memory 28 (shown in FIG. 3A). The processor 26 provides correction of the intensity values of pixels in the orientation-referenced image 14 for intensity sensitivity and intensity gain to provide a resulting image I(p,T) that has an absolute intensity calibration. The image I(p,T) enables the albedo AB for the obstructions OBS in the field of view FOVi to be established on a pixel by pixel basis, on an average basis or otherwise designated basis.

When the orientation-referenced image 14 includes a small region of pixels showing the reference reflector R having known albedo AB, the intensity values of the pixels that correspond to this small region may be used to normalize the intensity gain of the pixels in the orientation-referenced image 14 so that the albedo AB of the obstructions OBS within the field of view FOVi may be determined based on the known albedo AB of the reference reflector R. In this example where the reference reflector R is included in the apparatus A, the scale factor may be established by equating the values of the pixels in the orientation-referenced image 14 in the region of the reference reflector R to the values of known albedo AB for the reference reflector R to result in an absolute intensity calibration for the image I(p,T).

In an alternative example, the albedo AB of the obstructions OBS in various regions of the orientation-referenced image 14 are designated by a user of the solar resource measurement system. This enables the scale factor for the orientation-referenced image 14 to be established by equating the values of the pixels in these various regions of the orientation-referenced image 14 to the albedo AB that is designated by the user. Applying the resulting scale factor and the unnormalized calibration array to the orientation-referenced image 14 provides absolute intensity calibration for the image I(p,T), which enables the albedo AB of all of the obstructions OBS within the resulting to be determined. The user may also designate the albedo AB of the obstructions OBS that are below the skyline 108 based on knowledge or detection of the type of obstruction OBS and the typical albedo AB for that type of obstruction OBS. For example, grass may be detected within regions of the orientation-referenced image 14 and designated to have an albedo of 0.3, or snow may be detected within regions of the orientation-referenced image 14 and designated to have an albedo of 0.8, in order to provide an absolute intensity calibration for the image I(p,T). The user of the solar resource measurement system may also assign an albedo AB to each of the obstructions OBS in the orientation-referenced image 14 using values of albedo AB provided by a reference table, such as Table 1. Albedo AB for obstructions OBS within the orientation-referenced image 14 may alternatively be established with photographic techniques using a digital camera, calibrated with a reflector of known reflectance as disclosed by J. R. Miller et al. in BOREAS RSS-19 Seasonal Understory Reflectance Data NASA/TM 2000-209891, Vol. 77, pp. 1-18.

With these alternative methods of establishing the albedo AB of the obstructions OBS, regions within the orientation-referenced image 14 that have seasonal snowfall may be indicated, since the high albedo of snow may significantly change the solar radiation incident upon the tilted surface S in the winter. Based on indicated regions within the orientation-referenced image 14 that have seasonal snowfall, weather station data or satellite imagery may be used to increase the albedo AB in these indicated regions to the high value during periods of snowfall. In an alternative example, regions in the orientation-referenced image 14 that are below the skyline 108 may be designated for seasonal snowfall when appropriate. A user of the solar resource measurement system may also override default designations based on site-specific information, such as the snow-plowing of a parking lot that is within the field of view FOV of the tilted surface S.

The combined effect of the albedo AB for all of the obstructions OBS below the skyline 108, may be depicted in a determination of an average albedo AB_ave in step M30 according to embodiments of the present invention. In one example, the average albedo AB_ave is determined according to Equation 1 as a two-dimensional numerical integration of the image I(p, T), weighted by the solid angle within the skyline 108 and normalized by the total solid angle of the region below the skyline 108 for the zenith angles T in the range of zenith angles T such that T_skyline(p)<T≦90 degrees. The image I(p,T) typically represents the orientation-referenced image 14 calibrated for intensity sensitivity by the unnormalized calibration array, and normalized for intensity gain by the scale factor. In another example, the image I(p,T) represents a compilation of user-assigned or otherwise designated albedos AB for the obstructions OBS below the skyline 108 in the orientation-referenced image 14.

$$AB\_ave = \frac{{\sum }_{p = 0}^{359} {\sum }_{T = T\_skyline ( p )}^{90} I ( p , T ) * sin ( T )}{{\sum }_{p = 0}^{359} {\sum }_{T = T\_skyline ( p )}^{90} sin ( T )} \qquad Equation 1$$

Another measure of the solar resource that may be provided in step M30 according to alternative embodiments of the present invention includes a determination of the diffuse incident radiation RDiz referenced to the plane of the tilted surface S, as established according to Equation 2a or Equation 2b. For each azimuth angle p, the open sky 12 above the detected skyline 108 occupies a solid angle for the zenith angles T in the range of zenith angles 0<T<T_skyline that is represented by (1−cos(T_skyline(p)). Equation 2a represents this solid angle as a numerical integration of the zenith angles T_skyline(p), in one degree increments over all of the azimuth angles p in the field of view FOVi of the orientation-referenced image 14, normalized by the hemispherical solid angle of 360 degrees, and normalized to the diffuse incident radiation RDih referenced to the horizontal plane Ph. The diffuse incident radiation RDih, referenced to the horizontal plane Ph, is typically provided by weather station data, satellite data, mathematical or empirical modeling, measurements, or by any other suitable methods or techniques.

Equation 2a is based on the incident diffuse radiation RDi that is uniform for all zenith angles T that are in the open sky 12 above the skyline 108, where 0<T<T_skyline(p). In A New Simplified Version of the Perez Diffuse Radiation Model for Tilted Surfaces, Richard Perez et al. Solar Energy Vol. 39, pp. 221-231 (1987) teach that more sophisticated models may be used to accommodate for diffuse incident radiation RDi that is non-uniform. For example, the diffuse incident radiation RDi may have increased intensity in a circumsolar zone surrounding a beam of the direct solar radiation DSR provided by the sun 102, or the diffuse incident radiation RDi may have different intensity at low elevation angles near the region of the horizon. To accommodate for non-uniformity, the diffuse incident radiation RDi may include dependence on zenith angle T and azimuth angle p, represented as non-uniform diffuse incident radiation RDi′(T,p). Equation 2b uses this non-uniform diffuse incident radiation RDi′(T,p) to determine the non-uniform diffuse incident radiation RDiz′ referenced to the plane Pz of the tilted surface S. In this example, the diffuse incident radiation RDiz′ is expressed as a two-dimensional numerical integration of the non-uniform diffuse incident radiation RDi′(T,p) in regions of the open sky 12 that are above the skyline 108 for angles T, where 0<T<T_skyline(p) and 0<p<360, as an alternative to the closed form integral for the zenith angles T of Equation 2a. While Equation 2b may provide increased accuracy for the determined value of the diffuse incident radiation RDiz′, Equation 2b relies on modeling, measurement or other suitable characterization of the non-uniform diffuse incident radiation RDi′(T,p) as a function of zenith angle T and azimuth angle p, which may involve greater computational complexity.

$$\begin{matrix}RDiz = ( {\sum }_{p = 0}^{359} ( 1 - cos ( T\_skyline ( p ) ) ) / 360 ) * RDih & Equation 2 a \\ {RDiz}^{′} = \frac{{\sum }_{p = 0}^{359} {\sum }_{T = 0}^{T\_skyline ( p )} {RDi}^{′} ( T , p ) * sin ( T ) * RDih}{{\sum }_{p = 0}^{359} {\sum }_{T = 0}^{90} {RDi}^{′} ( T , p ) * sin ( T )} & Equation 2 b\end{matrix}$$

Another measure of the solar resource that may be provided in step M30 according to alternative embodiments of the present invention includes a determination of the diffuse reflected radiation RDrz referenced to the plane Pz of the tilted surface S. In one example, the diffuse reflected radiation RDrz is established according to Equation 3. The diffuse reflected radiation RDrz includes the total solar radiation TSR that is scattered by the albedo AB of the obstructions OBS in the field of view FOV of the tilted surface S that are below the skyline 108. The determination of diffuse reflected radiation RDrz in Equation 3 relies on a measurement, model or other means to establish the total solar radiation TSRh referenced to the horizontal plane Ph, which includes both direct solar radiation DSRh and diffuse solar radiation RDih, each referenced to the horizontal plane Ph.

$$RDrz = \frac{{\sum }_{p = 0}^{359} {\sum }_{T = T\_skyline ( p )}^{90} I ( p , T ) * sin ( T ) * TSRh}{{\sum }_{p = 0}^{359} {\sum }_{T = 0}^{90} sin ( T )} \qquad Equation 3$$

In some instances, a measurement of the diffuse incident radiation RDih may not be readily available, because this measurement typically involves complex instruments, such as a shadow band pyranometer. Accordingly, many weather stations typically provide a measurement of the total incident radiation TSRh referenced to the horizontal plane Ph using a simple, or low-cost pyranometer oriented in the horizontal plane Ph, rather than a measurement of the diffuse incident radiation RDih. While this total incident radiation TSRh may be used to determine the diffuse reflected radiation RDrz according to Equation 3, deriving a measure of the diffuse incident radiation RDih according to Equations 2a or 2b for the determination of the diffuse incident radiation RDiz typically involves further processing.

For example, in Empirical Modeling of Hourly Direct Irradiance by Means of Hourly Global Irradiance Energy 25 (2000) pp. 675-688, F. J. Batlles et. al. (hereinafter “Battles”) disclose models that estimate the relative fractions of diffuse incident radiation RDih and direct solar radiation DSRh referenced to the horizontal plane Ph, based on a measurement or other determination of the total solar radiation TSRh referenced to a horizontal plane Ph. The models of Batlles determine physical factors at the measurement site 10, such as a clearness index k, based on the latitude, longitude and the time. Other known models include the air mass AM or other physical factors to further improve accuracy of the estimates of the relative fractions of the diffuse incident radiation RDih and direct solar radiation DSRh from measurements of the total solar radiation TSRh. These models enable the diffuse incident radiation RDih to be determined from measurements or other determinations of the total horizontal radiation TSRh so that the diffuse incident radiation RDiz may be determined using Equations 2a or 2b.

FIGS. 3A-3B show an apparatus implementation of the solar resource measurement system according to alternative embodiments of the present invention. The apparatus A provides an example of a suitable instrument context for implementing the steps M10-M30 of the method M. In the block diagram of the apparatus A shown in FIG. 3A, the image acquisition system 16, includes the image sensor 18 and the fisheye lens 20 with optical axis O, and an orientation determination unit 24, typically including a tilt sensor 23 and compass 22. The orientation determination unit 24 may also include a gyroscope or other device, element or system suitable to establishing the orientation of the orientation-referenced image 14. The orientation determination unit 24 may establish the orientation of the orientation-referenced image 14 based on the position of the sun 102 in the orientation-referenced image 14, the latitude and longitude of the measurement site 10 and the time of day. Alternatively, the orientation determination unit 24 employs other known techniques for establishing the orientation of the orientation-referenced image 14 that is captured by the image acquisition system 16. The processor 26 and associated memory 28 are suitable for calibrating the image acquisition system 16, providing the detection of the skyline 108 within the orientation-referenced image 14 according to step M20, and determining the various measures of solar resource according to step M30 of the method M. The processor 26 may be included within the apparatus A as shown in FIG. 3B, or the processor 26 may be a computer or other suitable external device, element or system.

An interface 30 enables the apparatus A to receive a determination of the total solar radiation TSRh from a weather station, a determination of the total solar radiation TSRh from satellite data, or any other suitable measurements or determinations that may be used by the apparatus A to determine any of the measures of solar resource in step M30 of the method M according to the various embodiments of the present invention. The interface 30 also enables export of the orientation-referenced image 14, various measures of solar resource, calculations, or any other data from within the apparatus A. A display or other interface device 32 enables a user to control operation of the apparatus A and enables viewing of the orientation-referenced image 14, or viewing of various measures of solar resource, calculations, or any other data or results presented by the apparatus A of imported to the apparatus A.

The optionally-included reference reflector R may be attached to a housing or other attribute of the apparatus A, as shown in FIG. 3B. While FIG. 3B shows the apparatus A implemented as a self-contained solar resource measurement system, various components of the apparatus A are alternatively implemented separately, or distributed among two or more sub-systems.

The apparatus A of FIG. 3A shows optionally included solar radiation sensor 40, tilt sensor 44 and temperature sensor 42, enabling other measures of solar resource to be provided according to alternative embodiments of the present invention. One example measure of solar resource in step M30 includes a determination of the electrical output of one or more solar photovoltaic modules S at the tilt angle t. D. L. King et. al. (hereinafter “King”), in Photovoltaic Array Performance Model Sandia Laboratories Albuquerque N. Mex. 2004, Report SAND2004-3535, model the electrical output of solar photovoltaic modules S based on angle of incidence AOI of the direct solar radiation DSRz on the solar photovoltaic module S, and the air mass AM. The air mass AM represents the total atmospheric path traversed by the direct solar radiation DSRz and the total diffuse radiation RDz en route to the solar photovoltaic module S. The total diffuse radiation RDz represents the sum of the diffuse incident radiation RDiz and the diffuse reflected radiation RDrz, each referenced to the plane Pz of the solar photovoltaic module S. The model disclosed by King accommodates for response variations between different types of solar photovoltaic modules S, and for differences in sensitivities in responses of solar radiation sensors 40 relative to the response of an ideal pyranometer. This model enables silicon irradiance sensors, and other economical solar radiation sensors 40, to be calibrated to provide measurements of the total solar radiation TSRz with accuracies similar to those of more expensive measurement instruments that measure total solar radiation. The total solar radiation TSRz represents the sum of the direct solar radiation DSRz and the total diffuse radiation RDz in the plane Pz of the solar photovoltaic module S.

Determining the electrical output in step M30 of the method M according to these alternative embodiments of the present invention is illustrated in an example flow diagram F shown in FIG. 2B. The flow diagram F employs a single variable numerical estimation in combination with various aspects of the models of King and Battles, measurements of the total solar radiation TSRz, and the determination of the diffuse incident radiation RDiz and the diffuse reflected radiation RDrz, each referenced to the plane Pz of the solar photovoltaic module S. The numerical estimation includes designating a value for clearness index k as shown in step M32. The clearness index k represents the ratio of the total solar radiation TSRh referenced to a horizontal plane Ph on the surface of the earth, relative to the total solar radiation external to the earth's atmosphere and also referenced to a horizontal plane Ph, referred to as the extraterrestrial solar radiation TSEh. The extraterrestrial solar radiation TSEh may be determined in step M33 from calculations based on the latitude, longitude and time, or the TSEh may based on satellite data or established using other known means. In one example a software package titled SOLPOS, provided by NREL (National Renewable Energy Laboratory) is used to calculate the extraterrestrial solar radiation TSEh referenced to the horizontal plane Ph and the clearness index k. The SOLPOS software relies on known physical parameters such as the time of day, and latitude and longitude for the measurement site 10, the position of the sun 102, the tilt angle t of the tilted surface S, the azimuth orientation of the tilted surface S, the elevation angle e of the sun 102, and the angle of incidence AOI of the direct solar radiation DSRz on the solar photovoltaic module S.

The total solar radiation TSRh(k) referenced to the horizontal plane Ph for the designated clearness index k is determined in step M34 as the product of the clearness index k and the extraterrestrial solar radiation TSEh. The model of Battles enables the relative amounts of the direct solar radiation DSRh(k) and the diffuse radiation RDih(k) to be determined from the total solar radiation TSRh(k), which is relied upon in the model of King to predict the electrical output of the solar photovoltaic modules S.

In step M35, the direct solar radiation DSRz(k) referenced to the plane Pz of the solar photovoltaic module S is determined from the direct solar radiation DSRh(k) referenced to the horizontal plane Ph according to Equation 4.

DSRz(k)=DSRh(k)*cos(AOI)/sin(e) Equation 4

The total solar radiation TSRz(k) at each designated clearness index k, referenced to the plane of the tilted surface S is determined in step M37 and may be expressed as a summation in Equation 5: TSRz(k)=DSRz(k)+RDiz(k)+RDrz(k), where DSRz(k) may be determined according to Equation 4, RDiz(k) may be determined according to Equation 3, and where RDrz(k) may be determined according to Equations 2A or 2B at each designated clearness index k (step M36). According to alternative embodiments of the present invention, in step M36 one or both of the diffuse incident radiation RDiz and the diffuse reflected radiation RDrz in Equation 5 are estimated, for example by using the teachings of The Long-Term Average Performance of Flat-Plate Solar-Energy Collectors, Solar Energy, Vol. 7, p. 53, 1965, Benjamin Y. H. Liu and Richard C. Jordan, or using other suitable techniques to account for the albedo AB of the obstructions below the skyline 108 within the field of view FOVi of the solar photovoltaic module S in the determination of the diffuse incident radiation RDiz and the diffuse reflected radiation RDrz in step M36.

In step M38, a measurement is made of the total solar radiation TSRz referenced to the plane Pz of the solar photovoltaic module S. The measurement of the total solar radiation TSRz, designated as the measured total solar radiation MTSRz, is typically calibrated according to the methods of King. Step M39 of the method includes comparing the measured total solar radiation MTSRz to the total solar radiation TSRz(k) at various designations of the clearness index k. Numerical estimation yields the value of the clearness index k′ at which the measured total solar radiation MTSRz most closely approximates the total solar radiation TSRz(k′). The numerical estimation typically involves repeating steps M32-M39 of the flow diagram F at various designations of the clearness index k to establish the yielded value k′ of the clearness index k.

At the yielded value k′ of clearness index k, the direct solar radiation DSRz(k′) and the total diffuse radiation RDz(k′) may be used in the model of King to determine the electrical output of the solar photovoltaic module S in step M40. According to one example, one measure of electrical output of the solar photovoltaic module S is expressed as a measure of the short-circuit current Isc=10(Temp)*f1(AM)*(DSRz(k′)*f2(O0I)+RDz(k′)), where f1 indicates a function of the air mass AM, f2 indicates a function of the angle of incidence AOI of the direct solar radiation DSRz(k′) in the plane of the tilted surface S, and Temp indicates a temperature associated with the solar photovoltaic module S, wherein f1, f2, and I0 are provided in models such as those of King. In alternative examples, the models of King provide for determinations of the current Imp at the maximum power point, the voltage Vmp at the maximum power point, the power Pmp at the maximum power point, or the open circuit voltage Voc of the solar photovoltaic module S. Alternative measures of output power for the solar photovoltaic module S determined as the solar resource in steps M30-M40 include average power, peak power, and other known measures of electrical output of the solar photovoltaic modules S.

The solar resource provided in step M30 according to the embodiments of the present invention may include a determination of the albedo AB, average albedo AB_ave, the diffuse incident radiation RDiz, the diffuse reflected radiation RDrz, or the electrical output of a tilted surface S. In addition, these measures of solar resource may further include one or more measurements of solar radiation including the effects of shading of the direct solar radiation DSR and the diffuse incident radiation RDi by the obstructions OBS in the sun paths 104 as disclosed by MacDonald and others.

The example apparatus A of FIG. 3A shows the solar radiation sensor 40 and the tilt sensor 44 suitable for measuring the tilt angle t of the solar photovoltaic module S or the angle of the solar radiation sensor 40. The thermocouple, or other type of temperature sensor 42 is suitable to measure the backside temperature TEMP of a solar photovoltaic module S, used in the determination of Isc or for other measures of electrical output of the solar photovoltaic module S in step M40. The apparatus A may optionally include a clamp (not shown) to attach the various components of the apparatus A to the solar photovoltaic module S, and an interface with an electrical power meter (not shown) to measure the electrical output of the solar system within which the solar photovoltaic modules S are included. In one embodiment, the solar radiation sensor 40 is mechanically coupled to orientation-detection unit 24 to enable the orientation-detection unit 24 to establish the orientation of the solar radiation sensor 40, which obviates the need for the tilt sensor 44 to be included in the apparatus A. The solar radiation sensor 40 is suitable for providing measurements of total solar radiation MTSRZ in the plane Pz of the solar photovoltaic module S according to step M38 of the flow diagram F, and may be included as part of the site-specific determinations of solar resource according to embodiments of the present invention.

According to alternative embodiments of the present invention, the apparatus A includes the solar radiation sensor 40 to measure total solar radiation TSRZ referenced to the plane Pz of a solar photovoltaic module at a tilt angle t, the temperature sensor 42 to measure the temperature associated with the solar photovoltaic module S and the processor 26. The processor 26 is typically programmed to compare the measured total solar radiation MTSRZ referenced to the plane Pz of the solar photovoltaic module S to the total solar radiation TSRz(k) at a designated clearness index k that represents the sum of a direct solar radiation DSRz(k) referenced to the plane Pz of the solar photovoltaic module S at the designated clearness index k, the diffuse incident radiation RDiz referenced to the plane Pz of the solar photovoltaic module S at the designated clearness index k, and the diffuse reflected radiation RDrz(k) referenced to the plane Pz of the solar photovoltaic module S at the designated clearness index k. The processor 26 is also programmed to vary the designated clearness index k to numerically estimate the yielded clearness index k′ that minimizes the difference between the measured total solar radiation MTSRz referenced to the plane Pz of the solar photovoltaic module S and the determined total solar radiation TSRz referenced to the plane Pz of the solar photovoltaic module S. In this example, the processor 26 is further programmed to determine one or more measures of the electrical output of the solar photovoltaic module S based on the direct solar radiation DSRz(k′) referenced to the plane Pz of the solar photovoltaic module S at the yielded clearness index k′, and the diffuse incident radiation referenced to the plane of the solar photovoltaic module S at the yielded clearness index k′, the diffuse reflected radiation RDrz(k′) referenced to the plane Pz of the solar photovoltaic module S at the yielded clearness index k′, and a temperature Temp associated with the solar photovoltaic module S.

The determination of the solar resource, such as the albedo AB, average albedo AB_ave, the diffuse incident radiation RDiz, the diffuse reflected radiation RDrz, or the electrical output in step M30 may be combined with estimates of efficiencies of solar power inverters and other components of a solar system to provide estimates of the electrical output of the solar system for comparison with direct measurements of electrical output by an electrical power meter typically included in a solar system, and the temperature measured by the temperature sensor 42. This comparison provides an accurate estimate of a Performance Factor of the solar system, which represents the measured electrical output of the solar system relative to the electrical output for which the solar system was designed, as estimated by the various determinations of the solar resource in step M30 and the efficiency of the components of the solar system. Determining the Performance Factor at the time of commissioning the solar system may uncover improper module orientation, excessive shading, faulty or improper wiring, or other in construction or installation problems with the solar system. The Performance Factor may also be applied to monitor on-going power production of the solar system in which the tilted surface S is included. For example, Asaf Peleg, Michael Herzig, Shawn Kerrigan in published US patent application US 2010/0219983 A1 titled Comparable Diagnostics for Renewable Energy Power Systems (hereinafter “Peleg”) discloses monitoring that includes satellite data and/or production data from nearby solar systems. This monitoring technique may be refined by incorporating the site-specific determinations of the solar resources according to step M30 into the models to provide tighter correlation between individual sites. This enables smaller changes in performance of solar systems to be detected so that performance deficits and failures within the solar system can be identified.

According to alternative embodiments of the present invention, multiple determinations of the solar resource are made so that the multiple determinations may be averaged or interpolated to achieve alternative measures of the solar resource. The solar resource may also be determined at four corners of an array of solar photovoltaic modules S in a solar system. In these examples, the orientation-referenced images 14 that are captured in the determination of the solar resource may be processed sequentially, or the resulting orientation-referenced images 14 may be stored, and the further processing to determine the solar resource may be performed at a later time, for example in the processor 26, which may include a computer workstation or a server cloud-based computation system.

While the embodiments of the present invention have been illustrated in detail, it should be apparent that modifications and adaptations to these embodiments may occur to one skilled in the art without departing from the scope of the present invention as set forth in the following claims.

What is claimed is:

1. A method, comprising:
capturing an orientation-referenced image within a field of view of a tilted surface;
detecting a skyline within the orientation-referenced image to establish a set of zenith angles associated with the skyline over a range of azimuth angles;
determining a solar resource for the tilted surface from the orientation-referenced image and the established set of zenith angles over the range of azimuth angles, the solar resource accommodating for a range of zenith angles within the field of view of the tilted surface that is between the established set of zenith angles and a plane of the tilted surface at a tilt angle of the tilted surface.

2. The method of claim 1 wherein the solar resource includes at least one of a measure of an albedo within the field of view of the tilted surface, a diffuse reflected radiation in the field of view of the tilted surface and referenced to the plane of the tilted surface, an electrical output of a solar photovoltaic module at the tilt angle, and a diffuse incident radiation within the field of view of the tilted surface and referenced to the plane of the tilted surface, the diffuse incident radiation accommodating for a range of zenith angles within the field of view of the tilted surface that is between a normal axis to the plane of the tilted surface and the established set of zenith angles.

3. The method of claim 2 wherein the orientation-referenced image is normalized for intensity gain and calibrated for intensity sensitivity.

4. The method of claim 3 wherein the orientation-referenced image is normalized for intensity gain based on an image of a reference reflector that is included within the captured orientation-referenced image.

5. The method of claim 4 wherein determining the measure of the albedo includes designating the albedo associated with one or more obstructions within the orientation-referenced image.

6. The method of claim 4 wherein determining the measure of the albedo includes identifying one or more regions within the orientation-referenced image that have albedo variations that are seasonally-dependent.

7. The method of claim 1 wherein determining the solar resource includes determining a diffuse incident radiation in the field of view of the tilted surface and referenced to the plane of the tilted surface.

8. The method of claim 7 wherein determining the diffuse incident radiation referenced to the plane of the tilted surface is based on a diffuse incident radiation referenced to a horizontal plane.

9. The method of claim 8 wherein the diffuse incident radiation referenced to the horizontal plane is derived from a total solar radiation referenced to a horizontal plane, the total solar radiation including a direct solar radiation referenced to the horizontal plane and a diffuse solar radiation referenced to the horizontal plane.

10. The method of claim 1 wherein determining the solar resource includes determining a diffuse reflected radiation referenced to the plane of the tilted surface in the field of view of the tilted surface.

11. The method of claim 10 wherein the diffuse reflected radiation referenced to the plane of the tilted surface is further based on the a total solar radiation referenced to a horizontal plane, the total solar radiation including a direct solar radiation referenced to the horizontal plane and a diffuse solar radiation referenced to the horizontal plane.

12. The method of claim 1 wherein the tilted surface includes a solar photovoltaic module and wherein determining the solar resource includes determining an electrical output of the solar photovoltaic module.

13. The method of claim 12 wherein determining the electrical output of the solar photovoltaic module includes determining a direct solar radiation within the field of view of the tilted surface and referenced to a plane of the tilted surface, a diffuse incident radiation within the field of view of the tilted surface and referenced to the plane of the tilted surface, and a diffuse reflected radiation within the field of view of the tilted surface and referenced to the plane of the tilted surface.

14. The method of claim 13 wherein determining the direct solar radiation referenced to the plane of the tilted surface includes measuring a total solar radiation referenced to the plane of the tilted surface, the total solar radiation including the direct solar radiation referenced to the plane of the tilted surface and a diffuse solar radiation referenced to the plane of the tilted surface.

15. The method of claim 1 wherein the orientation-referenced image is captured with an image acquisition system that includes a fisheye lens.

16. The method of claim 1 wherein the orientation-referenced image is captured with an image acquisition system that includes a reflective dome.

17. The method of claim 1 wherein the orientation-referenced image includes a series of images that are stitched together to form a composite image.

18. The method of claim 9 wherein the total solar radiation referenced to a horizontal plane is provided by a weather station.

19. The method of claim 9 wherein the total solar radiation referenced to a horizontal plane is provided by satellite data.

20. The method of claim 1 further including determining a solar access for at least a direct solar radiation as shaded by one or more obstructions within the field of view of the tilted surface.

21. The method of claim 20 wherein the solar resource is used to monitor solar production of a solar system.

22. The method of claim 20 wherein the solar resource is used in commissioning of a solar system.

23. The method of claim 14 wherein measuring the total solar radiation referenced to the plane of the tilted surface further includes orienting a solar radiation sensor at the tilt angle of the tilted surface.

24. The method of claim 23 further including determining a solar access for at least a direct solar radiation as shaded by one or more obstructions within the field of view of the tilted surface.

25. An apparatus for determining a solar resource, the apparatus comprising:
an image acquisition system adapted to capture an orientation-referenced image within a field of view of a tilted surface, an orientation of the orientation-referenced image established according to an orientation determination unit;
a processor adapted to detect a skyline within the orientation-referenced image and to establish a set of zenith angles associated with the skyline over a range of azimuth angles, the processor further adapted to determine a solar resource for the tilted surface from the orientation-referenced image and the established set of zenith angles over the range of azimuth angles, the solar resource accommodating for a range of zenith angles within the field of view of the tilted surface that is between the established set of zenith angles and a plane of the tilted surface at a tilt angle of the tilted surface.

26. The apparatus of claim 25 wherein the processor normalizes the orientation-referenced image for intensity gain and calibrates the orientation-referenced image for intensity sensitivity.

27. The apparatus of claim 25 further comprising a reference reflector, wherein the orientation-referenced image includes an image of the reference reflector, and wherein the orientation-referenced image is normalized for intensity gain based on at least one of a reflectance of the reference reflector and an intensity value of the image of the reference reflector.

28. The apparatus of claim 25 wherein the solar resource includes at least one of a measure of an albedo within the field of view of the tilted surface, a diffuse reflected radiation in the field of view of the tilted surface and referenced to the plane of the tilted surface, an electrical output of a solar photovoltaic module at the tilt angle, and a diffuse incident radiation within the field of view of the tilted surface and referenced to the plane of the tilted surface, the diffuse incident radiation accommodating for a range of zenith angles within the field of view of the tilted surface that is between a normal axis to the plane of the tilted surface and the established set of zenith angles.

29. The apparatus of claim 25 wherein the image acquisition system includes a fisheye lens.

30. The apparatus of claim 25 wherein the image acquisition system includes a reflective dome.

31. The apparatus of claim 25 wherein the image acquisition system captures a series of images that are stitched together to form the orientation-referenced image.

32. The apparatus of claim 25 further comprising an interface adapted to receive a measure of a total solar radiation referenced to a horizontal plane.

33. The apparatus of claim 32 wherein the measure of total solar radiation referenced to the horizontal plane is provided by at least one of a weather station and satellite data.

34. The apparatus of claim 25 wherein the processor further determines a solar access for at least a direct solar radiation as shaded by one or more obstructions within the field of view of the tilted surface.

35. A method, comprising:
determining a total solar radiation referenced to a horizontal plane based on a designated clearness index;
determining a direct solar radiation referenced to a plane of a solar photovoltaic module at a tilt angle;
measuring a total solar radiation referenced to the plane of the solar photovoltaic module;
comparing the measured total solar radiation referenced to the plane of the solar photovoltaic module to a determined total solar radiation at the designated clearness index representing a sum of a direct solar radiation referenced to the plane of the solar photovoltaic module at the designated clearness index, the diffuse incident radiation referenced to the plane of the solar photovoltaic module at the designated clearness index, and the diffuse reflected radiation referenced to the plane of the solar photovoltaic module at the designated clearness index;
varying the designated clearness index to numerically estimate a yielded clearness index that minimizes the difference between the measured total solar radiation referenced to the plane of the solar photovoltaic module and the determined total solar radiation referenced to the plane of the solar photovoltaic module;
determining one or more measures of electrical output of the solar photovoltaic module based on at least a direct solar radiation referenced to the plane of the solar photovoltaic module at the yielded clearness index, and the diffuse incident radiation referenced to the plane of the solar photovoltaic module at the yielded clearness index, and a diffuse reflected radiation referenced to the plane of the solar photovoltaic module at the yielded clearness index.

36. The method of claim 35 wherein determining a total solar radiation referenced to a horizontal plane based on the designated clearness index includes determining an extraterrestrial solar radiation.

37. The method of claim 35 wherein determining the direct solar radiation referenced to a plane of a solar photovoltaic module at the tilt angle includes determining a direct solar radiation referenced to a horizontal plane.

38. An apparatus, comprising:
a solar radiation sensor adapted to measure total solar radiation referenced to the plane of a solar photovoltaic module at a tilt angle;
a temperature sensor adapted to measure a temperature associated with the solar photovoltaic module;
a processor programmed to compare the measured total solar radiation referenced to the plane of the solar photovoltaic module to a determined total solar radiation at a designated clearness index representing a sum of a direct solar radiation referenced to the plane of the solar photovoltaic module at the designated clearness index, the diffuse incident radiation referenced to the plane of the solar photovoltaic module at a designated clearness index, and the diffuse reflected radiation referenced to the plane of the solar photovoltaic module at the designated clearness index, the processor programmed to vary the designated clearness index to numerically estimate a yielded clearness index that minimizes the difference between the measured total solar radiation referenced to the plane of the solar photovoltaic module and the determined total solar radiation referenced to the plane of the solar photovoltaic module, the processor further programmed to determine one or more measures of electrical output of the solar photovoltaic module based on the direct solar radiation referenced to the plane of the solar photovoltaic module at the yielded clearness index, and the diffuse incident radiation referenced to the plane of the solar photovoltaic module at the yielded clearness index, the diffuse reflected radiation referenced to the plane of the solar photovoltaic module at the yielded clearness index, and a temperature associated with the solar photovoltaic module.

39. The apparatus of claim 38 wherein at least one of the diffuse incident radiation referenced to the plane of the solar photovoltaic surface and the diffuse reflected radiation referenced to the plane of the solar photovoltaic surface are estimated.
